(19) United States
(12) Patent Application Publication
(10) Pub. No.: US 2005/0271377 A1
(43) Pub. Date: Dec. 8, 2005

(54) Apparatus for processing multimedia data in portable device having NAND flash memory and method thereof

(76) Inventor: Seong-Jun Hong, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/132,683

(22) Filed: May 18, 2005

(30) Foreign Application Priority Data
Jun. 4, 2004 (KR) 10-2004-0040934

(51) Int. Cl. G06F 17/30

(52) U.S. Cl. 396/211

(57) ABSTRACT

Provided is a multimedia data processing apparatus for use in a portable device having a NAND flash memory. The multimedia data processing apparatus is capable of processing multimedia data with no regard to capacity of a random access memory by configuring database information in the NAND flash memory when the multimedia data is stored, and directly accessing the corresponding multimedia data in the NAND flash memory in real-time by using the configured database information when the corresponding multimedia data is processed.

### FIELD OF INVENTION

The present invention relates to a multimedia data processing apparatus in a portable device having a NAND flash memory and a method thereof, more particularly, to a multimedia data processing apparatus for configuring a database information in a NAND flash memory when multimedia data is stored, directly accessing the corresponding multimedia data stored in the NAND flash memory in real-time using the configured database information when the corresponding multimedia data is processed, and a method thereof.

### DESCRIPTION OF PRIOR ART

The term portable device may include a portable wireless communication terminal, a multimedia player and a MPEG Audio Layer-3 (MP3) player, capable of transmitting/receiving voice, text and image data via wireless communication, such as a mobile communication terminal, a Personal Communication Service (PCS) terminal, a Personal Digital Assistant (PDA), a smart-phone, International Mobile Telecommunication-2000 (IMT-2000) terminal, a wireless Local Area Network (LAN) terminal and the like.

Further, the multimedia data may include MP data, moving picture data, image data and the like. Hereinafter, MP3 data will be taken as an example to describe the present invention.

The wireless communication terminal has many advantages. Among them all, mobility that is provided to a calling part would be seen as the most outstanding benefit. Due to the mobility, the number of the wireless communication subscribers has been exponentially increasing. Recently, the wireless communication terminals are widely used.

However, there is a need for a multi-functional wireless communication terminal capable of providing the wireless communication terminal user with a variety of supplementary services as well as the merit of such a mobility feature.

Accordingly, the recently introduced wireless communication terminals have a radio broadcast receiving function, a music, e.g., MP3, playing function, a massaging function, a blood sugar measuring function, an ultrasonic imaging function and the like. Particularly, the music playing function is one of the most popular functions among young people.

On the other hand, a flash memory is widely used as a large capacity memory for storing multimedia data in the portable device.

The flash memory is a highly-integrated non-volatile memory device formed with one cell (or transistor), which is capable of electrically erasing and programming data and continuously storing data without requiring power.

There are a NOR flash memory and a NAND flash memory which are different from each other in terms of internal scheme. The NOR flash memory has cells coupled in parallel and the NAND flash memory has serially coupled cells.

More particularly, the NAND flash memory is capable of reading or writing data based on a unit of a page (a page including 512 bytes) with a NAND controller and it should execute stored data necessarily in a random access memory.

Further, the NAND flash memory is commonly used for a digital camera or an MP3 player because the manufacturing cost of the NAND flash memory is less than the NOR flash memory and the NAND flash memory has a mass capacity.

On the other hand, the NOR flash memory is capable of addressing based on the unit of 1 byte or 4 bytes so as to perform direct access without the control of a controller.

Further, the NOR flash memory is commonly used for a wireless communication terminal or a set-top box because the NOR flash memory has a shorter data access time than the NAND flash memory and it can store data safely.

Generally, the NOR flash memory having direct access capacity is used for the wireless communication terminal.

However, since the NOR flash memory has small capacity to store mass multimedia data, e.g., moving picture data, MP3 data, image data and etc., there is a need for a wireless communication terminal having the NAND flash memory of mass capacity.

Herein, it will be described for the conventional multimedia data processing method for use in the conventional portable device having the NAND flash memory.

In the conventional multimedia data processing method, multimedia data in the code region of the NAND flash memory is stored in the random access memory during booting and, then, the corresponding multimedia data that is stored in the random access memory is processed upon a request from a user.

However, there is a limit in storing all the multimedia data in the random access memory because the capacity of the random access memory is less than the NAND flash memory.

Therefore, there is a need for processing the corresponding multimedia data by directly accessing the NAND flash memory in real-time during multimedia data processing.

### SUMMARY OF INVENTION

It is, therefore, an object of the present invention to provide a multimedia data processing apparatus for a portable device having a NAND flash memory, which is capable of processing multimedia data regardless of capacity of a random access memory by configuring a database information in the NAND flash memory when the multimedia data is stored, and directly accessing the corresponding multimedia data in the NAND flash memory in real-time by using the configured database information when the corresponding multimedia data is processed, and a method thereof.

In accordance with an aspect of the present invention, there is provided a multimedia data processing apparatus in a portable device, which includes a NAND flash memory, a memory controlling unit, a random access memory and a controlling unit. The NAND flash memory stores multimedia data and database information under the control of the memory controlling unit. The memory controlling unit configures the database information for stores information that is related to the multimedia data, stores the multimedia data and the configured database information into the NAND flash memory, copies the database information that is stored at the NAND flash memory into the random access memory, accesses the multimedia data that is stored at the NAND flash memory using the copied database information and transfers the accessed multimedia data to the random access memory. The random access memory stores the multimedia data that is transferred and the database information from the NAND flash memory under the control of the memory controlling unit. The controlling unit controls the memory controlling unit and processing the multimedia data that is stored at the random access memory.

In accordance with another aspect of the present invention, there is provided a multimedia data processing method for use in a portable device, which includes the steps of configuring database information when multimedia data is stored in a NAND flash memory; storing the configured database information in the NAND flash memory; copying the database information that stored in the NAND flash memory into a random access memory during booting; accessing the NAND flash memory using the database information based on a multimedia data processing request to store a predetermined amount of the corresponding multimedia data into the random access memory; and processing the corresponding multimedia data that is stored in the random access memory.

Other objects and advantages of the invention will be apparent to those with skill in the art upon overview of the following detailed description. Further, it will be appreciated that the objects and advantages of the invention may be implemented with means in the accompanying claims and their combinations.

### BRIEF DESCRIPTION OF THE DRAWINGS

The above and other objects and features of the present invention will become apparent from the following description of preferred embodiments taken in conjunction with the accompanying drawings, in which:

FIG. 1 shows configuration of a multimedia data processing apparatus in a portable device having a NAND flash memory in accordance with an embodiment of the present invention;

FIG. 2 illustrates a database information storing state in a NAND flash memory in accordance with an embodiment of the present invention;

FIG. 3 illustrates a database information configuration in accordance with an embodiment of the present invention;

FIG. 4 illustrates a multimedia data processing method for use in a portable device having a NAND flash memory in accordance with one embodiment of the present invention;

FIG. 5 illustrates a structure of MP3 data in accordance with an embodiment of the present invention; and

FIG. 6 describes an MP3 data access algorithm in accordance with the present invention.

### DETAILED DESCRIPTION OF INVENTION

Hereinafter, a multimedia data processing apparatus in accordance with the present invention will be described in detail referring to the accompanying drawings.

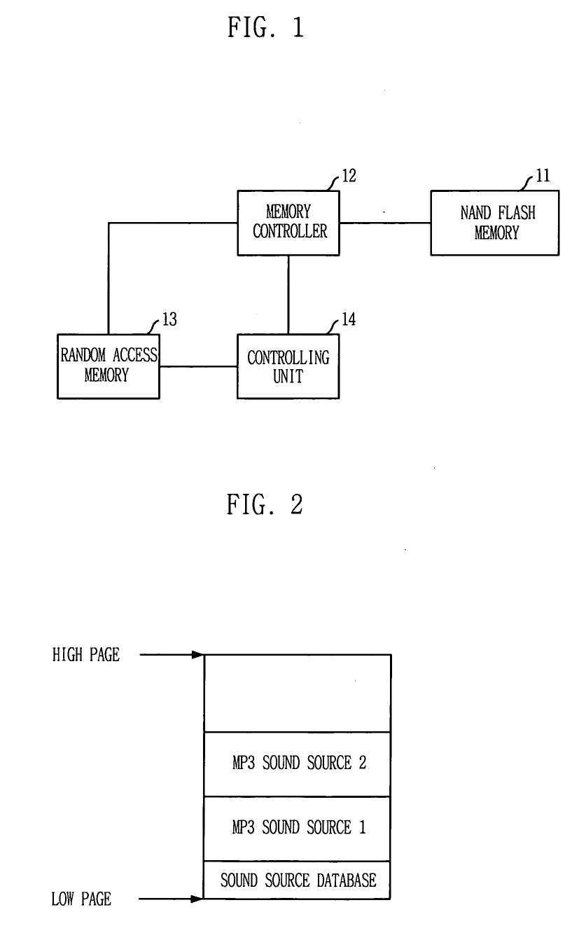

FIG. 1 shows a configuration of a multimedia data processing apparatus for a portable device having a NAND flash memory in accordance with an embodiment of the present invention.

As shown in FIG. 1, the multimedia data processing apparatus in a portable device having a NAND flash memory of the invention includes a NAND flash memory 11, a memory controller 12, a random access memory 13, and a controlling unit 14. The NAND flash memory 11 stores multimedia data and database information on a basis of a page, a page including 512 bytes, under the control of the memory controller 12. The memory controller 12 configures in the random access memory 13 database information for storing information related to the multimedia data when the multimedia data is stored. After the multimedia data is stored in the NAND flash memory 11, the memory controller 12 stores the database information in the NAND flash memory 11 and copies the database information that is stored in the NAND flash memory 11 into the random access memory 13. Upon a request from the controlling unit 14, the memory controller 12 accesses the multimedia data that is stored in the NAND flash memory 11 using the copied database information, and transfers the accessed multimedia data to the random access memory 13. The random access memory 13 stores the multimedia data and the database information from the NAND flash memory 111 under the control of the memory controller 12. The controlling unit 14 controls the memory controller 12 and processes the multimedia data that is stored in the random access memory 13.

Herein, the NAND flash memory 11 stores MP3 data from a page that comes after the storage of the database information except a particular page space reserved for the database information to be stored upon the control of the memory controller 12, as illustrated in FIG. 2.

At this point, the database information is stored temporarily in the random access memory 13. When all the multimedia data is completely stored in the NAND flash memory 11, the memory controller 12 stores the database information of the random access memory 13 in a low page, which is a space for storing the database information, of the NAND flash memory 11.

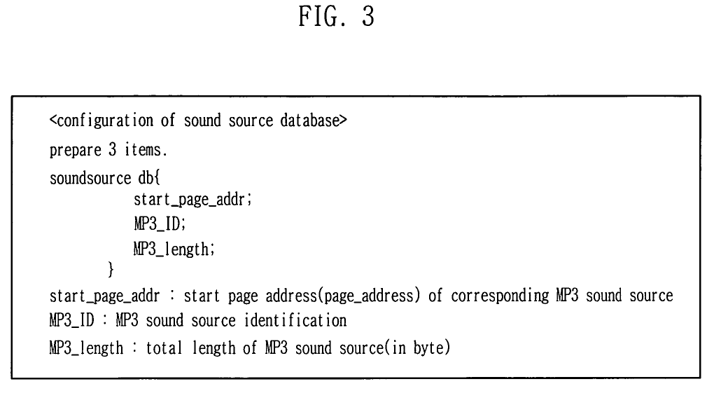

On the other hand, the database information contains a start page address (start_page_addr) of the MP3 data and an identification of the MP3 data (MP3_ID), and a total length of the MP3 data (MP3_length), as shown in FIG. 3.

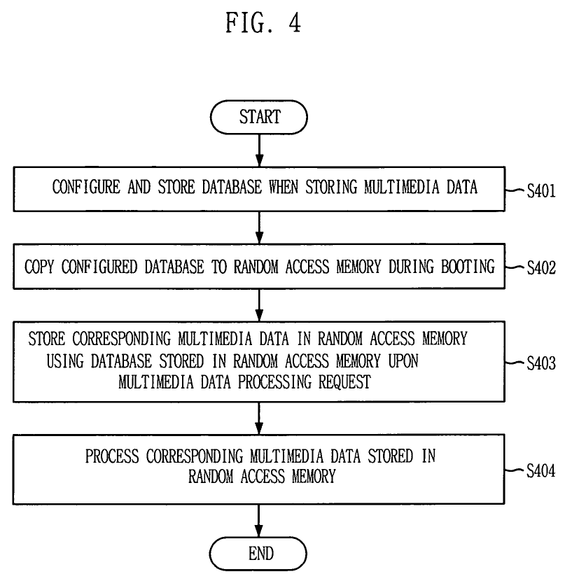

FIG. 4 illustrates a multimedia data processing method for a portable device having a NAND flash memory 11 in accordance with an embodiment of the present invention.

First, as described in FIG. 2, when the multimedia data is stored into the NAND flash memory 11, the database information is configured in the random access memory 13 and, after storing the multimedia data in the NAND flash memory 11, the configured database information is stored in the reserved space for the database information in the NAND flash memory 11, at step S401.

At step S402, when the multimedia data is stored completely, information pre-stored in the random access memory 13 is used as the database information configured in the random access memory 13. If the NAND flash memory 11 is booted after the data storage, the database information stored in the NAND flash memory 11 can be copied into the random access memory 13.

At step S403, upon a multimedia data processing request from a user, the multimedia data stored in the NAND flash memory 11 is copied into the random access memory 13 using the stored database information. At this point, the multimedia data can be read from the NAND flash memory 11 by a predetermined size at a time, for example, the multimedia data can be read on a 1600-byte basis. The multimedia data that is stored in a buffer of the random access memory 13 is processed, at step S404.

The above procedure will be described in detail with an example of MP3 data.

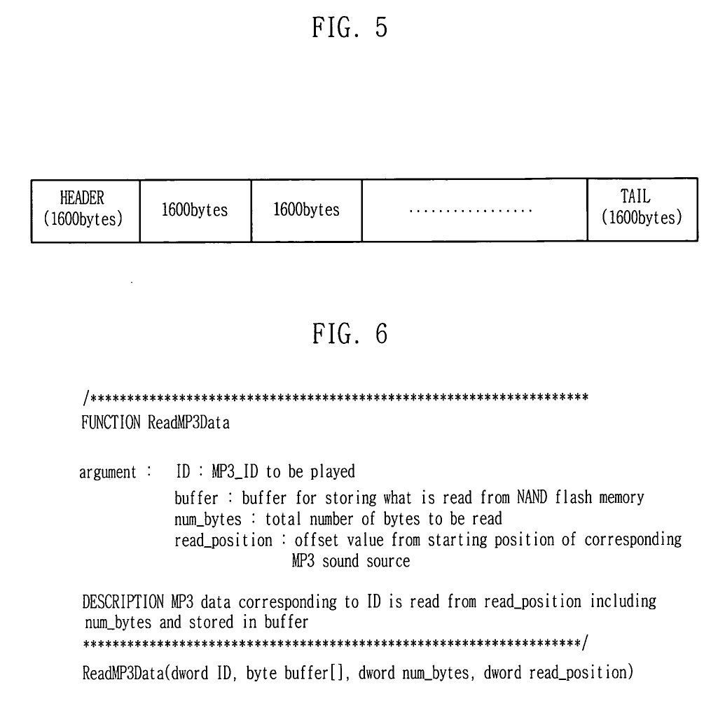

Based on an MP3 data execution request from the user, the mp3 data stored in the NAND flash memory 11 is copied to the random access memory 13 using the stored database information. At this point, as shown in FIG. 5, the MP3 data which has a header, a body and a tail can be read in a predetermined segment size, for example, in a segment size of 1,600 bytes. Herein, the segment of 1600 bytes is an arbitrary value and it may be changed. The information is read based on a unit of a page because the memory controller 12 can only access to the NAND flash memory 11 in the unit of a page.

Describing the storing procedure into the random access 13 in detail, after the header (1,600 bytes) is read by using the start page address of the corresponding MP3 of the database information (start_page_addr), the tail (1,600 bytes) is read by using the total length information of the MP3 of the database information (MP3_length).

Then, an offset value at which the tail starts is calculated to store the multimedia data after the header to the offset into the buffer of the random access memory 13.

It is appreciated that the above procedure may be readily implemented through MP3 data access algorithm as shown in FIG. 6.

As described above, the present invention has an effect for processing multimedia data with no regard to capacity of a random access memory by configuring database information in the NAND flash memory when the multimedia data is stored and directly accessing the corresponding multimedia data in the NAND flash memory in real-time by using the configured database when the corresponding multimedia data is processed.

The present application contains subject matter related to Korean patent application No. 2004-40934, filed in the Korean Intellectual Property Office on Jun. 4, 2004, the entire contents of which is incorporated herein by reference.

While the present invention has been described with respect to the particular embodiments, it will be apparent to those skilled in the art that various changes and modifications may be made without departing from the spirit and scope of the invention as defined in the following claims.

1. A multimedia data processing apparatus in a portable device, comprising:
a NAND flash memory;
a memory controller;
a random access memory; and
a controller for controlling the memory controller and processing the multimedia data stored in the random access memory,
wherein the NAND flash memory stores multimedia data and database information under the control of memory controller, the memory controller configure the database information for storing information that is related to the multimedia data, store the multimedia data and the database information into the NAND flash memory, copy the database information that is stored in the NAND flash memory into a random access memory, access the multimedia data that is stored in the NAND flash memory using the copied database information and transfer the accessed multimedia data to the random access memory, and the random access memory stores the multimedia data and the database information transferred from the NAND flash memory under the control of the memory controller.

2. The multimedia data processing apparatus as recited in claim 1, wherein the database information includes the start page address of the multimedia data, the identification of the multimedia data and the total length of the multimedia data.

3. The multimedia data processing apparatus as recited in claim 2, wherein the memory controller configure the database information for storing the information that is related to the multimedia data in the random access memory when the multimedia data is stored into the NAND flash memory, then store the database information into the NAND flash memory after storing the multimedia data in the NAND flash memory, and then access the multimedia data that is stored in the NAND flash memory using the database information based on a request from the controller to transfer the accessed multimedia data to the random access memory.

4. The multimedia data processing apparatus as recited in claim 3, wherein the memory controller first store the multimedia data from the low page side to the high page side of the NAND flash memory after the space for the database information in the low page side and then store the database information that is stored in the random access memory into the low page side, which is a space for the database, of the NAND flash memory.

5. A multimedia data processing method for use in a portable device, comprising the steps of:
configuring database information when multimedia data is stored into a NAND flash memory;
storing the configured database information into the NAND flash memory;
accessing the NAND flash memory using the database information based on a multimedia data processing request to store a predetermined amount of the corresponding multimedia data into the random access memory; and
processing the corresponding multimedia data that is stored in the random access memory.

6. The multimedia data processing method as recited in claim 5, further comprising:
copying the database information that is stored in the NAND flash memory into a random access memory during booting.

7. The multimedia data processing method as recited in claim 5, wherein the database information includes the start page address of the multimedia data, the identification of the multimedia data and total length of the multimedia data.

8. The multimedia data processing method as recited in claim 7, wherein storing the corresponding multimedia data includes:
confirming a header of the corresponding multimedia data using the start page information of the multimedia data;
calculating an offset value of the starting point of the tail of the corresponding multimedia data using the total length of the multimedia data; and
accessing the multimedia data excluding the header and the tail using the calculated offset value to store the accessed multimedia data into the random access memory.

9. A hand-held electronic device comprising:
a NAND flash memory storing data and a database comprising information indicative of a location of the data in the NAND flash memory;
a NAND flash memory controller configured to control data reading from and data writing to the NAND flash memory;
a volatile memory;
a processor configured to loading the database from the NAND flash memory to the volatile memory;
wherein the processor is configured to control the NAND flash memory controller and the volatile memory to copy only a portion of the data from the NAND flash memory to the volatile memory; and
wherein the processor is configured to process the portion of the data stored in the volatile memory.

10. The device of claim 9, wherein the information comprises a start address of the data and a size of the data stored in the NAND flash memory.

11. The device of claim 10, wherein the processor is further configured to control copying of an additional portion of the data from the NAND flash memory to the volatile memory, and wherein the additional portion of the data is consecutively located following the portion of the data in the NAND flash memory.

12. The device of claim 9, further comprising a multimedia processing function.

13. A method of processing data stored in a NAND flash memory, the method comprising:
providing a NAND flash memory storing data and a database comprising locational information of the data in the NAND flash memory;
providing a volatile memory;
determining the location of the data upon receiving an instruction to process the data;
copying only a portion of the data from the NAND flash memory to the volatile memory;
processing the portion of the data stored in the volatile memory; and
repeating the copying and processing steps for another portion of the data.

14. The method of claim 13, wherein the locational information comprises a start address of the data and a size of the data stored in the NAND flash memory.

15. The method of claim 13, wherein the volatile memory is a random access memory.

16. The method of claim 13, wherein determining the location of the data comprises copying the database from the NAND flash memory to the volatile memory and reading the database while stored in the volatile memory.

17. The method of claim 16, wherein copying the database to the volatile memory is carried out when the volatile memory is powered up or when the instruction to process the data is received.

18. The method of claim 13, wherein providing a NAND flash memory comprises storing the data in the NAND flash memory, and creating and storing the database in the NAND flash memory.

19. The method of claim 13, wherein the data comprises at least one of sound data and image data.

20. The method of claim 13, wherein the repeating continues until the entire set of the data is processed.
